(19) United States
(12) Patent Application Publication
(10) Pub. No.: US 2007/0065695 A1
(43) Pub. Date: Mar. 22, 2007

(54) Coolant flow estimation for the thermal loop of a fuel cell system using stack loss power

(76) Inventors: Oliver Maier, Worms (DE); Sascha Schaefer, Bad Camberg (DE); Thomas Weispfenning, Ober-Ramstadt (DE); Peter Willimowski, Darmstadt (DE); Rolf Isermann, Seeheim (DE)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/304,349

(22) Filed: Dec. 15, 2005

Related U.S. Application Data
(60) Provisional application No. 60/719,528, filed on Sep. 22, 2005.

(51) Int. Cl. H01M 8/04

(52) U.S. Cl. 429/24; 429/13; 429/26

(57) ABSTRACT

A thermal sub-system for a fuel cell system that calculates a desired volume flow or mass flow of a cooling fluid pumped through a fuel cell stack solely on thermal stack power loss and cooling fluid temperature. An algorithm calculates a power loss of the stack and then calculates the temperature of the stack based on the power loss and dissipated heat power from the stack. The algorithm uses the temperature of the stack and the temperature of the cooling fluid out of the stack to determine the dissipated heat power. The algorithm then uses the temperature of the stack, the temperature of the cooling fluid into the stack and the temperature of the cooling fluid out of the stack to determine the flow.

### CROSS REFERENCE TO RELATED APPLICATIONS

This application claims the benefit of the priority date of U.S. Provisional Patent Application No. 60/719,528, titled Coolant Flow Estimation for the Thermal Loop of a Fuel Cell System by Using Stack Loss Power, filed Sep. 22, 2005.

### BACKGROUND OF THE INVENTION

1. Field of the Invention

This invention relates generally to a thermal sub-system for a fuel cell system and, more particularly, to a thermal sub-system for a fuel cell system that calculates the volume flow of the cooling fluid using the power loss from the fuel cell stack.

2. Discussion of the Related Art

Hydrogen is a very attractive fuel because it is clean and can be used to efficiently produce electricity in a fuel cell. A hydrogen fuel cell is an electrochemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode. The work can act to operate a vehicle.

Proton exchange membrane fuel cells (PEMFC) are a popular fuel cell for vehicles. The PEMFC generally includes a solid polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA).

Several fuel cells are typically combined in a fuel cell stack to generate the desired power. For the automotive fuel cell stack mentioned above, the stack may include two hundred or more individual cells. The fuel cell stack receives a cathode reactant gas, typically a flow of air forced through the stack by a compressor. Not all of the oxygen is consumed by the stack and some of the air is output as a cathode exhaust gas that may include liquid water and/or water vapor as a stack by-product. The fuel cell stack also receives an anode hydrogen reactant gas that flows into the anode side of the stack.

It is necessary that a fuel cell stack operate at an optimum relative humidity and temperature to provide efficient stack operation and durability. A typical stack operating temperature for automotive applications is about 80° C. The stack temperature provides the relative humidity within the fuel cells in the stack for a particular stack pressure. Excessive stack temperatures above the optimum temperature may damage fuel cell components and reduce the lifetime of the fuel cells. Also, stack temperatures below the optimum temperature reduces the stack performance. Therefore, fuel cell systems employ thermal sub-systems that control the temperature within the fuel cell stack to maintain a thermal equilibrium.

A typical thermal sub-system for an automotive fuel cell stack includes a radiator, a fan and a pump. The pump pumps a cooling fluid, such as a water/glycol mixture, through cooling fluid channels within the fuel cell stack where the cooling fluid collects the stack waste heat. The cooling fluid is directed through a pipe or hose from the stack to the radiator where it is cooled by ambient air either forced through the radiator from movement of the vehicle or by operation of the fan. Because of the high demand of radiator airflow to reject a large amount of waste heat to provide a relatively low operating temperature, the fan is usually powerful and the radiator is relatively large. The physical size of the radiator and the power of the fan have to be higher compared to those of an internal combustion engine of similar power rating because of the lower operating temperature of the fuel cell system and the fact that only a comparably small amount of heat is rejected through the cathode exhaust in the fuel cell system.

The fuel cell stack requires a certain cooling fluid flow rate to maintain the desired stack operating temperature. The cooling fluid flow rate has to be large enough so that the fuel cell stack does not get hot spots that could damage the cells. Various system parameters determine the cooling fluid flow rate including, but not limited to, the current density of the stack, the cooling fluid temperature, the cooling fluid viscosity, system pressure drop, valve position, etc. For a thermal sub-system employing a centrifugal flow pump, the cooling fluid flow correlates to the system pressure drop because there is no independence of pressure as in displacement pumps.

Because fuel cell systems are thermally sensitive, the cooling fluid flow typically requires a flow controller, such as a proportional-integral (PI) feedback controller, well known to those skilled in the art. Feedback controllers typically require a proportionally controllable pump. Because the pressure is unknown, the actual cooling fluid flow is necessary for the flow controller.

Currently, flow sensors are used to measure the flow rate of the cooling fluid in the coolant loop, and a suitable algorithm is employed to compare the measured flow rate to the desired flow rate for the particular operating parameters of the fuel cell system. However, flow sensors used for this purpose are typically not reliable. Further, these flow sensors are large, heavy and costly. It is desirable to eliminate the flow sensor from the thermal sub-system of a fuel cell system.

### SUMMARY OF THE INVENTION

In accordance with the teachings of the present invention, a thermal sub-system for a fuel cell system is disclosed that calculates a desired volume flow or mass flow of a cooling fluid based on thermal stack power loss and cooling fluid temperature. The thermal sub-system includes a pump that pumps the cooling fluid through a coolant loop and a fuel cell stack in the system. A controller employs an algorithm that controls the speed of the pump to provide the volume flow of the cooling fluid. The algorithm calculates a power loss of the stack, and then calculates the temperature of the stack based on the power loss and dissipated heat power from the stack. The algorithm uses the temperature of the stack and the temperature of the cooling fluid out of the stack to determine the dissipated heat power. The algorithm then uses the temperature of the stack, the temperature of the cooling fluid into the stack and the temperature of the cooling fluid out of the stack to determine the flow.

Additional features of the present invention will become apparent from the following description and appended claims, taken in conjunction with the accompanying drawings.

### BRIEF DESCRIPTION OF THE DRAWINGS

FIG. 1 is a block diagram of a fuel cell system including a thermal sub-system employing a controller that determines cooling fluid flow based on thermal stack power loss and cooling fluid temperature, according to an embodiment of the present invention; and

FIG. 2 is a block diagram of the algorithm used in the system in FIG. 1 for determining the cooling fluid volume flow.

### DETAILED DESCRIPTION OF THE EMBODIMENTS

The following discussion of the embodiments of the invention directed to a thermal sub-system in a fuel cell system that determines the volume flow of the cooling fluid using only stack power loss and cooling fluid temperature is merely exemplary in nature, and is in no way intended to limit the invention or its applications or uses.

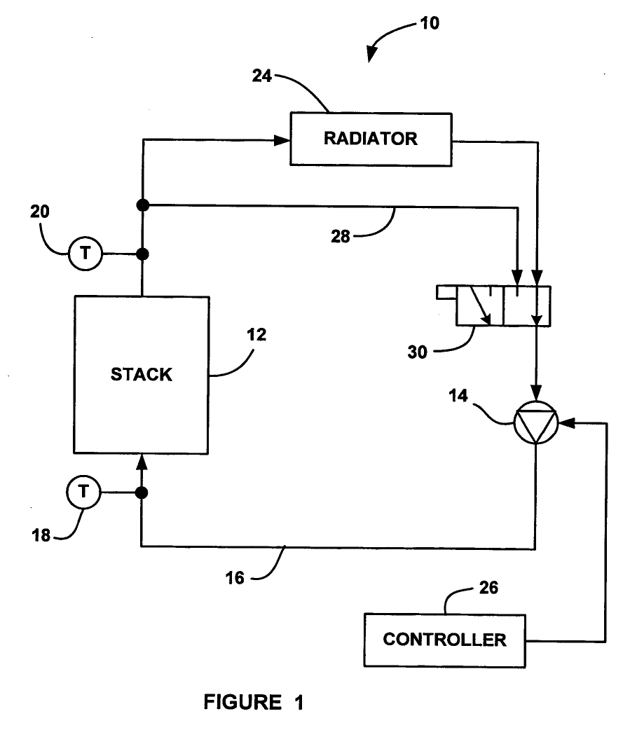

FIG. 1 is a schematic diagram of a thermal sub-system for a fuel cell system 10 including a fuel cell stack 12. A coolant loop pump 14 pumps a suitable cooling fluid, such as a water/glycol mixture, through a coolant loop 16 and the stack 12. As will be discussed in detail below, a controller 26 controls the pump 14, where the controller 26 employs an algorithm that uses stack power loss and cooling fluid temperature to determine the volume flow of the cooling fluid through the loop 16 for the particular operating parameters of the system 10, such as stack current density.

A first temperature sensor 18 measures the temperature of the cooling fluid in the coolant loop 16 as it is being input into the stack 12 and a second temperature sensor 20 measures the temperature of the cooling fluid in the coolant loop 16 as it is being output from the stack 12. A suitable chilling device, such as a radiator 24, cools the cooling fluid in the coolant loop from the stack 12 so that it is reduced in temperature. The radiator 24 may include a fan (not shown) that forces cooling air through the radiator 12 to increase the cooling efficiency of the radiator 24. Further, other cooling devices can also be used instead of the radiator 24. A by-pass line 28 in the coolant loop 16 allows the radiator 24 to be by-passed if the operating temperature of the stack 12 is not at the desired operating temperature, such as during system start-up. A by-pass valve 30 is selectively controlled to distribute the cooling fluid through either the radiator 24 or the by-pass line 28 to help maintain a desired operating temperature. The valve 30 can be any suitable valve for this purpose that can selectively provide a certain amount of the cooling fluid to the radiator 24 and the by-pass line 28.

As will be discussed in detail below, the present invention determines the volume flow of the cooling fluid using only thermal stack power loss and cooling fluid temperature to set the speed of the pump 14 to provide the desired stack temperature. A power loss will occur as result of the stack 12 producing electrical power. The power loss is equal to heat power. The fuel cell stack 12 can thus be seen as a heat exchanger because it heats the cooling fluid flowing therethrough. The equations below define the heat exchanger behavior of the fuel stack 12 to determine the thermal power loss of the stack 12.

The stack temperature T_{Stk} based on the thermal mass of the stack 12 can be defined as:

$${T}_{stk} = \frac{1}{{C}_{p , Stk}} \cdot \int ( {\dot{Q}}_{in} - {\dot{Q}}_{out} ) ⅆ t \qquad ( 1 )$$

Where T_{Stk} is the temperature of the stack 12, C_{p,Stk} is the heat capacity of the stack 12, \dot{Q}ᵢₙ is the heat power provided by the structure of the stack 12 and \dot{Q}ₒᵤₜ is the dissipated heat power from the stack 12 to the cooling fluid. In this nomenclature, lower case means “specific property”, i.e., heat capacity divided by mass, and upper case means “specific property multiplied by mass.”

The power loss Pₗₒₛₛ of the stack 12 equals the heat power \dot{Q}ᵢₙ removed from the stack 12 as:
\dot{Q}ᵢₙ=Pₗₒₛₛ=(U₀−U_{Stk})·I_{Stk} (2)
Where U₀ is the open circuit voltage of the stack 12, U_{Stk} is the stack voltage, and I_{Stk} is the stack current.

The dissipated heat power value \dot{Q}ₒᵤₜ can be defined as the heat power provided to the cooling fluid from the structure of the stack 12 as shown in equation (3) below.
\dot{Q}ₒᵤₜ=Gₜₕ*(T_{Stk}−Tₒᵤₜ) (3)
Where Gₜₕ is the heat transfer conductivity between the stack 12 and the cooling fluid, and Tₒᵤₜ is the temperature of the cooling fluid exiting the stack 12.

The dissipated heat power value \dot{Q}ₒᵤₜ can also be defined as the difference between the heat energy of the cooling fluid as it enters the stack 12 and the heat energy of the cooling fluid as it exits the stack 12 by equation (4) below.
\dot{Q}ₒᵤₜ=\dot{m}·c_{p,Fld}·(Tₒᵤₜ−Tᵢₙ) (4)
Where \dot{m} is the mass flow rate of the cooling fluid, C_{p,Fld} is the specific heat capacity of the cooling fluid and Tᵢₙ is the temperature of the cooling fluid entering the stack 12.

The volume flow \dot{V} can be converted to the mass flow \dot{m} by equation (5) below:
\dot{m}=\dot{V}ρ (5)
Where ρ is the coolant density.

By setting equation (3) equal to equation (4) and converting the mass flow rate \dot{m} to volume flow rate (dynamic behavior is included in T_{Stk}), the steady state volume flow value \dot{V} can be determined as:

$$\dot{V} = \frac{1}{ρ} \cdot \frac{{G}_{th} \cdot ( {T}_{stk} - {T}_{out} )}{{c}_{p , Fld} ( {T}_{out} - {T}_{in} )} \qquad ( 6 )$$

Equation (6) is used for the steady state calculation of the volume flow value \dot{V} of the cooling fluid. The temperature value Tᵢₙ is measured by the temperature sensor 18 and the temperature value Tₒᵤₜ is measured by the temperature sensor 20. The density ρ of the cooling fluid is a function of the mean temperature and the properties of the cooling fluid.

From the volume flow value \dot{V} and equations (1) and (2), the mass flow rate \dot{m} of the cooling fluid also can be calculated as:

$$\dot{m} = \frac{1}{{c}_{p , Fld} \cdot ( {T}_{out} - {T}_{in} )} \cdot ( \frac{1}{1 + s \cdot \frac{{C}_{p , Stk}}{{G}_{th}}} \cdot {P}_{loss} - \frac{s \cdot \frac{{C}_{p , Stk}}{{G}_{th}}}{1 + s \cdot \frac{{C}_{p , Stk}}{{G}_{th}}} ) \qquad ( 7 )$$

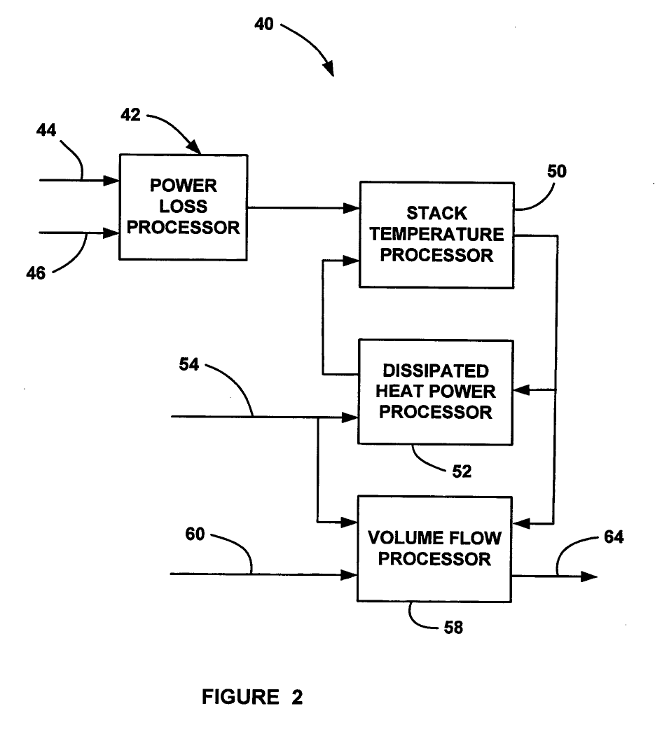

FIG. 2 is a block diagram 40 of the algorithm employed in the controller 26 for determining the volume flow value \dot{V} or mass flow value \dot{m} of the cooling fluid using the thermal power loss of the stack 12, as discussed above. The stack voltage value U_{Stk} on line 44 and the stack current value I_{Stk} on line 46 are sent to a power loss processor 42 that calculates the heat loss power value Pₗₒₛₛ using equation (2). The heat loss power value Pₗₒₛₛ from the processor 42 and the dissipated heat power value \dot{Q}ₒᵤₜ are applied to a stack temperature processor 50 that generates the stack temperature value T_{Stk} using equation (1). The measured output temperature on line 54 of the cooling fluid from the stack 12 provided by the temperature sensor 20 and the stack temperature value T_{Stk} are applied to a dissipated heat power processor 52 that calculates the heat power value \dot{Q}ₒᵤₜ using equation (3). The output temperature Tₒᵤₜ of the cooling fluid on the line 54, the inlet temperature Tᵢₙ of the cooling fluid from the temperature sensor 18 on line 60 and the stack temperature T_{Stk} are applied to a volume flow processor 58 that calculates the volume flow value \dot{V} using equation (6) on output line 64. The processor 58 can also calculate the mass flow rate value \dot{m}, as discussed above.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for determining a desired flow of a cooling fluid through a fuel cell stack, said method comprising:
determining a power loss from the stack;
determining dissipated heat power from the stack;
determining the temperature of the stack based on the power loss and the dissipated heat power;
revising the dissipated heat power using the temperature of the stack and the temperature of the cooling fluid out of the stack; and
calculating the flow of the cooling fluid based on the temperature of the stack, the temperature of the cooling fluid out of the stack and the temperature of the cooling fluid into the stack.

2. The method according to claim 1 wherein determining the power loss from the stack includes using the open circuit voltage of the stack, the stack voltage and the stack current.

3. The method according to claim 1 wherein determining and revising the dissipated heat power includes using the equation:
\dot{Q}ₒᵤₜ=Gₜₕ·(T_{Stk}−Tₒᵤₜ)
where Gₜₕ is the heat transfer conductivity between the stack and the cooling fluid, T_{Stk} is the temperature of the stack and Tₒᵤₜ is the temperature of the cooling fluid out of the stack.

4. The method according to claim 3 wherein determining and revising the dissipated heat power also includes using the equation:
where \dot{m} is the mass flow of the cooling fluid through the stack, Tₒᵤₜ is the temperature of the cooling fluid out of the stack, Tᵢₙ is the temperature of the cooling fluid into the stack and C_{p,Fld} is the specific heat capacity of the cooling fluid.

5. The method according to claim 4 wherein calculating the flow includes calculating a volume flow using the equation:
$$\dot{V} = \frac{1}{ρ} \cdot \frac{{G}_{th} \cdot ( {T}_{Stk} - {T}_{out} )}{{c}_{p , Fld} ( {T}_{out} - {T}_{in} )}$$
where \dot{V} is the volume flow, ρis the density of the cooling fluid, Gₜₕ is the heat transfer conductivity between the stack and the cooling fluid, C_{p,Fld} is the specific heat capacity of the cooling fluid, T_{Stk} is the temperature of the stack, Tₒᵤₜ is the temperature of the cooling fluid being output from the stack and Tᵢₙ is the temperature of the cooling fluid being input to the stack.

6. The method according to claim 1 wherein determining the temperature of the stack includes using the equation:
$${T}_{Stk} = \frac{1}{{C}_{p , Stk}} \cdot \int ( {\dot{Q}}_{in} - {\dot{Q}}_{out} ) ⅆ t$$
where T_{Stk} is the temperature of the stack, C_{p,Stk} is the heat capacity of the stack, \dot{Q}ᵢₙ is the heat power produced by the stack and \dot{Q}ₒᵤₜ is the dissipated heat power from the stack.

7. The method according to claim 1 wherein calculating the flow of the cooling fluid includes calculating the volume flow of the cooling fluid.

8. The method according to claim 1 wherein calculating the flow of the cooling fluid includes calculating the mass flow of the cooling fluid.

9. The method according to claim 1 wherein the fuel cell stack is part of a fuel cell system is on a vehicle.

10. A method for determining a volume flow of a cooling fluid being pumped by a pump through a fuel cell system including a fuel cell stack, said method comprising:
determining a power loss from the stack using an open circuit voltage of the stack, the stack voltage and the stack current;
determining dissipated heat power from the stack using a first equation and a second equation;
determining the temperature of the stack based on the power loss from the stack and the dissipated heat power from the stack;
revising the dissipated heat power using the first equation; and
calculating the volume flow of the cooling fluid using the first equation and the second equation.

11. The method according to claim 10 wherein the first equation is:
\dot{Q}ₒᵤₜ=Gₜₕ*(T_{Stk}−Tₒᵤₜ)
where Gₜₕ is the heat transfer conductivity between the stack and the cooling fluid, T_{Stk} is the temperature of the stack and Tₒᵤₜ is the temperature of the cooling fluid out of the stack.

12. The method according to claim 11 wherein the second equation is:
\dot{Q}ₒᵤₜ=\dot{m}·c_{p,Fld}·(Tₒᵤₜ−Tᵢₙ)
where \dot{m} is the mass flow of the cooling fluid through the stack, Tₒᵤₜ is the temperature of the cooling fluid out of the stack, Tᵢₙ is the temperature of the cooling fluid into the stack and C_{p,Fld} is the specific heat capacity of the cooling fluid.

13. The method according to claim 10 wherein determining the temperature of the stack includes using the equation:
$${T}_{Stk} = \frac{1}{{C}_{p , Stk}} \cdot \int ( {\dot{Q}}_{in} - {\dot{Q}}_{out} ) ⅆ t$$
where T_{Stk} is the temperature of the stack, C_{p,Stk} is the heat capacity of the stack, \dot{Q}ᵢₙ is the heat power produced by the stack and \dot{Q}ₒᵤₜ is the dissipated heat power from the stack.

14. The method according to claim 10 wherein calculating the volume flow includes using the equation:
$$\dot{V} = \frac{1}{ρ} \cdot \frac{{G}_{th} \cdot ( {T}_{Stk} - {T}_{out} )}{{c}_{p , Fld} ( {T}_{out} - {T}_{in} )}$$
where \dot{V} is the volume flow, ρ is the density of the cooling fluid, Gₜₕ is the heat transfer conductivity between the stack and the cooling fluid, C_{p,Fld} is the specific heat capacity of the cooling fluid, T_{Stk} is the temperature of the stack, Tₒᵤₜ is the temperature of the cooling fluid being output from the stack and Tᵢₙ is the temperature of the cooling fluid being input to the stack.

15. A fuel cell system comprising:
a fuel cell stack;
a pump for pumping a cooling fluid through the stack; and
a controller for controlling the pump to provide a desirable flow of the cooling fluid through the stack, said controller determining a power loss from the stack, determining dissipated heat power from the stack, determining the temperature of the stack based on the power loss and the dissipated heat power, revising the dissipated heat power using the temperature of the stack and the temperature of the cooling fluid out of the stack, and calculating the flow of the cooling fluid based on the temperature of the stack, the temperature of the cooling fluid out of the stack and the temperature of the cooling fluid into the stack.

16. The system according to claim 15 wherein the controller determines the power loss from the stack using the open circuit voltage of the stack, the stack voltage and the stack current.

17. The system according to claim 15 wherein the controller determines and revises the dissipated heat power using the equation:
\dot{Q}ₒᵤₜ=Gₜₕ·(T_{Stk}−Tₒᵤₜ)
where Gₜₕ is the heat transfer conductivity between the stack and the cooling fluid, T_{Stk} is the temperature of the stack and Tₒᵤₜ is the temperature of the cooling fluid out of the stack.

18. The system according to claim 17 wherein the controller also determines and revises the dissipated heat power using the equation:
\dot{Q}ₒᵤₜ=\dot{m}·c_{p,Fld}·(Tₒᵤₜ−Tᵢₙ)
where this the mass flow of the cooling fluid through the stack, Tₒᵤₜ is the temperature of the cooling fluid out of the stack, Tᵢₙ is the temperature of the cooling fluid into the stack, and C_{p,Fld} is the specific heat capacity of the cooling fluid.

19. The system according to claim 18 wherein the controller calculates the volume flow using the equation:
$$\dot{V} = \frac{1}{ρ} \cdot \frac{{G}_{th} \cdot ( {T}_{Stk} - {T}_{out} )}{{c}_{p , Fld} ( {T}_{out} - {T}_{in} )}$$
where \dot{V} is the volume flow, ρ is the density of the cooling fluid, Gₜₕ is the heat transfer conductivity between the stack and the cooling fluid, C_{p,Fld} is the specific heat capacity of the cooling fluid, T_{Stk} is the temperature of the stack, Tₒᵤₜ is the temperature of the cooling fluid being output from the stack and Tᵢₙ is the temperature of the cooling fluid being input to the stack.

20. The system according to claim 15 wherein the controller determines the temperature of the stack using the equation:
$${T}_{Stk} = \frac{1}{{C}_{p , Stk}} \cdot \int ( {\dot{Q}}_{in} - {\dot{Q}}_{out} ) ⅆ t$$
where T_{Stk} is the temperature of the stack, C_{p,Stk} is the heat capacity of the stack, \dot{Q}ᵢₙ is the heat power produced by the stack and \dot{Q}ₒᵤₜ is the dissipated heat power from the stack.

21. The system according to claim 15 wherein the controller flow calculates the volume flow of the cooling fluid.

22. The system according to claim 15 wherein the controller flow calculates the mass flow of the cooling fluid.
